(19) United States
(12) Patent Application Publication
(10) Pub. No.: US 2025/0151770 A1
(43) Pub. Date: May 15, 2025

(54) FLOODABLE PEELING VESSEL

(71) Applicant: Heat and Control, Inc., Flower Mound, TX (US)

(72) Inventor: Rick Wendell Bajema, Lewisville, TX (US)

(21) Appl. No.: 19/020,592

(22) Filed: Jan. 14, 2025

Related U.S. Application Data
(60) Provisional application No. 63/389,909, filed on Jul. 17, 2022.

(51) Int. Cl. A23N 7/02; A47J 17/18

(52) U.S. Cl. CPC A23N 7/02; A47J 17/18

(57) ABSTRACT

A floodable peeling device having a vessel with an interior cavity surrounded by an interior wall, an inlet proximal to a first end and off-center relative to a center axis, an outlet proximal to a second end, a section of the interior cavity intermediate the first end and the second end having a circular cross-section and a plurality of peeling members supported within the interior cavity and proximal to the interior wall. A stream of fluid enters the interior cavity through the inlet and a plurality of bodies having peels thereon are introduced into the interior cavity proximal to the inlet. The stream of fluid causes the plurality of bodies to be moved in a spiraling pattern within the interior cavity of the vessel, thereby causing the bodies to engage the plurality of peeling members, each of which, upon engagement with a body, removes a piece of the peel.

### STATEMENT OF RELATED APPLICATIONS

This application depends from and claims priority to U.S. Provisional Patent Application Ser. No. 63/389,909 filed on Jul. 17, 2022.

### BACKGROUND

### Field of the Invention

The present invention relates to an apparatus for removing an exterior surface from a plurality of bodies having an exterior surface such as, for example, but not by way of limitation, a skin, a peel, a husk, a sheath or a hide. More specifically, the present invention relates to a floodable peeling vessel for enabling the removed exterior surface to be washed from the equipment within which the exterior surface is removed and, optionally, to be conveniently carried in a stream of a fluid that is discharged from the vessel to a downstream collector.

### Background of the Related Art

Certain foodstuffs are in the form of bodies. Some of these foodstuffs are fruits and vegetables such as, for example, potatoes, apples or oranges. Some of these foodstuffs can be skinned or peeled and the skinned or peeled plurality of bodies can then be used to prepare foods that are then packaged and sold to consumers. A variety of different methods are currently used to remove some or all of the exterior surface from a body. Some hand-held implements may be used for this purpose such as, for example, a potato peeler or a knife. Some of these implements require a large amount of labor and time to use.

### BRIEF SUMMARY

One embodiment of the floodable peeling vessel of the present invention comprises a vessel having a first end, a second end with an outlet, an interior cavity intermediate the first end and the second end, and an interior wall surrounding the interior cavity with at least a portion of the interior cavity having a rounded or circular cross-section and a center axis extending therethrough, a plurality of peeling members supported within the interior cavity and proximal to the interior wall, an inlet coupled to the vessel to introduce an inlet stream having an inlet direction that is directed off-center relative to the center axis of the interior cavity of the vessel, the inlet being proximal to the first end of the vessel and an outlet proximal to the second end of the vessel, wherein introducing a stream of a fluid through the inlet and into the interior cavity of the vessel fills the interior cavity from the inlet to the outlet and produces a spinning vortex of the fluid about the center axis and within the at least a portion of the interior cavity and wherein introducing a plurality of bodies with exterior surfaces into the interior cavity while continuing to introduce the stream of the fluid through the inlet causes the plurality of bodies to be accelerated in a spiraling pathway about the center axis by the spinning vortex and causes the plurality of bodies to engage the interior wall and at least some of the plurality of peeling members.

In one embodiment of the floodable peeling vessel of the present invention, the center axis is vertical. One embodiment of the floodable peeling vessel of the present invention further comprises a body chute fluidically coupled to the vessel and through which the plurality of bodies can be introduced into the interior cavity. One embodiment of the floodable peeling vessel of the present invention includes a chute having a discharge end that is proximal to the first end of the vessel to introduce a stream of a plurality of bodies into the vessel proximal to the first end. In that embodiment, the residence time is maximized or prolonged so that, as the bodies are propelled along the pathway, the bodies encounter a greater number of peeling members prior to arriving at the outlet.

One embodiment of the floodable peeling vessel of the present invention includes a plurality of peeling members that are supported on a liner that is removably receivable within the interior cavity and positioned on the liner to engage bodies as they are propelled through the pathway by the stream of fluid introduced at the inlet. In one embodiment of the floodable peeling vessel of the present invention, the plurality of peeling members comprise the edges of a plurality of apertures, holes or perforations in the liner. In another embodiment of the floodable peeling vessel of the present invention, the plurality of peeling members are connected to and supported on the interior wall of the interior cavity.

One embodiment of the floodable peeling vessel of the present invention includes a strategically positioned spill trough disposed proximal to the outlet from the vessel and proximal to the second end of the vessel to receive from the vessel the plurality of bodies emerging from the vessel, the fluid, and a plurality of pieces of the exterior surface that have been removed from the bodies. In one embodiment of the floodable peeling vessel of the present invention, the spill trough has a first portion to receive the plurality of bodies, the fluid and the pieces, and a second portion to discharge at least one of the bodies, the fluid and the pieces. For example, but not by way of limitation, the second portion of the spill trough may include a trough with drain holes to allow the fluid phase and at least some of the pieces from the spill trough while continuing to move the bodies, less the exterior surfaces, to another location.

In one embodiment of the floodable peeling vessel of the present invention, the inlet is coupled to the vessel to introduce the inlet stream having a direction that is tangential to the center axis and proximal to the interior wall of the vessel. In one embodiment of the floodable peeling vessel of the present invention, the inlet is strategically coupled to the vessel at a location and at an angle to introduce a stream of fluid into the vessel to tangentially impinge on the interior wall of the interior cavity of the vessel. Tangential impingement, as that term is used herein, means that the stream of fluid emerging from the inlet and introduced into the interior cavity of the vessel is directed so as to be gradually redirected by the interior wall along the interior wall and to maintain flow speed with gradual change in direction. This manner of introduction of the stream of fluid has a great impact on the sustainability of the spiraling flow along the pathway and, as a result, on the propulsion of the bodies along the pathway to engage the peeling members supported within the interior cavity of the vessel. Embodiments of the floodable peeling apparatus of the present invention utilize a spiraling vortex pathway that moves the bodies about the center axis of the interior cavity of the vessel from the first end to the outlet proximal to the second end. Embodiments of this type provide optimal utilization of the plurality of distributed peeling members supported within the interior cavity. Embodiments of the floodable peeling apparatus of the present invention may utilize a spiraling vortex pathway that spins about a vertical center axis, a horizontal center axis or an inclined center axis. Strategic selection of the orientation of the center axis should be made based on factors including the density of the bodies from which the exterior surface is to be removed. Embodiments of the floodable peeling apparatus of the present invention may include an inclined or vertical center axis in which the first end is disposed lower than the second end, and other embodiments of the floodable peeling apparatus of the present invention may include a declined or vertical center axis in which the first end is disposed higher than the second end. Bodies having a density that is greater than that of the fluid of which the stream of fluid is comprised may be introduced into an embodiment of the floodable peeling apparatus having an inclined or vertical center axis with the first end disposed lower than the second end to increase the residence time of the bodies. Alternately, bodies having a density that is less than that of the fluid of which the stream of fluid is comprised may be introduced into an embodiment of the floodable peeling apparatus having a declined or vertical center axis with the first end disposed higher than the second end to increase the residence time of the bodies. Similarly, strategic selection of the fluid can be used to influence the residence time of bodies of a known density.

Embodiments of the floodable peeling apparatus of the present invention may perform differently depending on, among other factors, the dimensions of the interior cavity of the vessel of the apparatus and the velocity and the volumetric rate with which the stream of fluid is introduced into the interior cavity through the inlet. The orientation of the center axis, the specific gravity of the fluid and the density of the bodies from which pieces of peeling are to be removed also affect the performance of the apparatus. The volumetric rate at which a stream of fluid is introduced into the interior cavity of the vessel of an embodiment of the apparatus having an interior cavity of given dimensions may be optimized for best performance. A spin rate of the spiraling vortex created by the off-center (relative to a plane orthogonal to a center axis) introduction of a stream of fluid of a given specific gravity will in part determine the velocity with which the bodies that become entrained in the flow will engage the peeling members that are supported within the interior cavity of the vessel. The volumetric rate at which the stream of fluid is introduced into the interior cavity of the vessel of the apparatus, the specific gravity of the fluid, the density of the bodies and the dimensions of the interior cavity will impact the rate at which entrained bodies will move from the first end of the vessel to the second end of the vessel. These factors will produce a residence time for the bodies that reflects the duration with which a body will typically remain within the spiraling vortex pathway intermediate the first end and the second end of the vessel.

An insufficient flow velocity component along the center axis about which the spiraling vortex pathway spins may cause bodies to either remain in the vessel for an excessive amount of time, resulting in the loss of more than just the exterior peel of the bodies due to an unwanted duration of engagement with the plurality of peeling members, or it may cause the bodies to sink out of the spiraling vortex pathway due to having a density that is excessively greater than that of the fluid. An excessive flow velocity component along the center axis about which the spiraling vortex pathway spins may cause bodies to remain within the interior cavity of the vessel of the apparatus for an insufficient amount of time and to be discharged from the second end of the vessel before a sufficient amount of the exterior peel is removed by engagement with the plurality of peeling members supported within the interior cavity of the vessel.

Some embodiments of the floodable peeling apparatus of the present invention may be used for continuously receiving and peeling a plurality of bodies. The bodies may be continuously introduced into the first end of the interior cavity of the vessel of the apparatus by way of, for example, a body chute, and peeled bodies may be continuously discharged from the second end of the interior cavity of the vessel of the apparatus. Other embodiments of the floodable peeling apparatus of the present invention may be used for receiving and peeling a batch comprising a plurality of bodies. The plurality of bodies, or batch of bodies, may be introduced into the interior cavity of the vessel of the apparatus and peeled bodies may be discharged from the second end until all of the plurality of bodies are peeled, and then the apparatus may be reset for receiving a successive batch.

In some embodiments of the floodable peeling apparatus of the present invention in which the spiraling vortex pathway surrounds a center axis that is vertical, the first end of the interior cavity of the vessel of the apparatus at which the inlet is disposed may be vertically beneath the second end at which peeled bodies and the stream of fluid, with pieces of peels removed from the bodies are entrained therein, may be discharged from the interior cavity of vessel. In other embodiments of the floodable peeling apparatus of the present invention in which the spiraling vortex pathway surrounds a center axis that is vertical, the first end of the interior cavity of the vessel of the apparatus at which the inlet is disposed may be vertically above the second end at which peeled bodies and the stream of fluid, with pieces of peels removed from the bodies entrained therein, may be discharged from the interior cavity of the vessel. These embodiments may be optimized to adjust for the relative density of the plurality of bodies compared to the specific gravity of the stream of fluid. For example, but not by way of limitation, buoyant bodies, which are bodies having a density that is less than the density of the stream of fluid, will require a greater downwardly velocity component of the spiraling vortex pathway to move the bodies downwardly along the center axis about which the spiraling vortex pathway spins than will non-buoyant bodies. The denser the plurality of bodies, a lesser downwardly velocity component of the spiraling vortex pathway may be used because the denser plurality of bodies may utilize the natural sinking action of the plurality of bodies to move the bodies from the first end to the second end of the interior cavity of the vessel of the apparatus. Turning back to the example of an interior cavity having a vertical center axis and the inlet at the first end of the interior cavity of the vessel disposed vertically beneath the outlet proximal to the second end of the interior cavity of the vessel, bodies that are denser than the stream of fluid will require an upward component of velocity of the stream of fluid that is sufficient to overcome the density of the bodies and move them upwardly towards the second end of the interior cavity of the vessel. The greater the density of the bodies, the more the upward component of velocity of the stream of fluid will be required to move the bodies upwardly to overcome the tendency of the bodies to sink within the interior cavity of the vessel.

In some embodiments of the floodable peeling apparatus of the present invention, weighting agents may be added to the stream of fluid to adjust the specific gravity of the fluid to optimize performance and to adjust residence time of the bodies within the apparatus. For example, but not by way of limitation, the addition of salt to a fluid stream of water will cause the specific gravity of the water to increase. Similarly, in some embodiments of the floodable peeling apparatus of the present invention, viscosity agents may be added to the stream of fluid to adjust the viscosity of the fluid to optimize performance and to adjust residence time of the bodies within the apparatus.

In some embodiments of the floodable peeling apparatus of the present invention, one or more vanes, fins or deflection members may be disposed within the interior cavity of the vessel of the apparatus to impart enhanced swirling or spinning action to the stream of fluid with the entrained plurality of bodies therein to optimize performance and to adjust residence time of the bodies within the apparatus. In this manner, the spiraling flow pathway can be manipulated to, for example, increase or decrease residence time and to thereby increase or decrease the number of times a body might encounter a peeling member supported within the interior cavity of the vessel.

In some embodiments of the floodable peeling apparatus of the present invention, the plurality of peeling members may comprise, for example, but not by way of limitation, brush elements, wires, fins or other flexible members instead of or in addition to rigid peeling members such as, for example, but not by way of limitation, blades or other structures having rigid edges. For example, but not by way of limitation, in some embodiments the plurality of peeling members may be a plurality of flexible wires supported proximal to the interior wall of the vessel of the floodable peeling apparatus, the plurality of wires extending radially inwardly towards the center axis. It will be understood that the diameter, distribution, density, length and/or flexibility of the plurality of wires may be optimized for the type of bodies from which peels or skins are to be removed. The texture and thickness of the peel of the bodies to be removed should be considered in optimizing the process to be implemented using an embodiment of the floodable peeling apparatus of the present invention.

An embodiment of the floodable peeling apparatus of the present invention is adapted for receiving and peeling or skinning a batch of bodies and may include passages through or in the interior wall of the vessel for the passage of fluid and solid pieces removed from the peeled or skinned bodies while retaining the bodies within the vessel of the floodable peeling vessel. In other embodiments of the floodable peeling vessel of the present invention, unpeeled or unskinned bodies may be fed continuously into the floodable peeling apparatus, a stream of liquid may be continuously fed into the floodable peeling apparatus, the stream of liquid with solid pieces removed from the bodies is continuously removed, displaced or drained from the floodable peeling apparatus and peeled or skinned bodies are continuously removed from the vessel of the floodable peeling apparatus. In the latter embodiments, the stream of liquid may be routed to a settling tank or through filters or screens to remove the entrained solid pieces therein and thereby condition the discharged stream of liquid for being recirculated into the floodable peeling apparatus.

### BRIEF DESCRIPTION OF THE SEVERAL VIEWS OF THE DRAWINGS

FIG. 1 is a perspective view of an embodiment of a floodable peeling apparatus of the present invention.

FIG. 2 is a sectional elevation view of the floodable peeling apparatus of FIG. 1.

FIG. 3 is a sectional plan view of the floodable peeling apparatus of FIGS. 1 and 2 showing an inlet that is off-center relative to a center axis of the interior cavity of the vessel, the inlet being proximal to the floor of the floodable peeling apparatus.

FIG. 4 is an elevation view of a removably insertable liner that can be used to support a plurality of peeling members within the interior cavity of a vessel of an embodiment of a floodable peeling apparatus of the present invention.

FIG. 5 is an elevation view of an embodiment of a floodable peeling apparatus of the present invention having a centralized body chute for introducing a plurality of bodies into the interior cavity of the vessel of the floodable peeling apparatus for peeling, the body chute terminating prior to engaging a floor of the vessel and being centered about the central axis.

### DETAILED DESCRIPTION

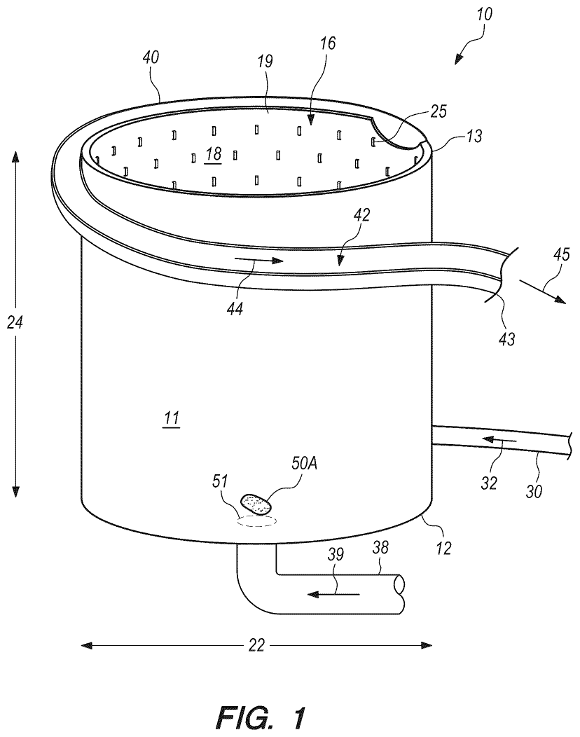

FIG. 1 is a perspective view of an embodiment of a floodable peeling apparatus 10 of the present invention. The floodable peeling apparatus 10 of FIG. 1 includes a floodable peeling vessel 11. The vessel 11 has a first end 12 and a second end 13 spaced apart from the first end 12. The vessel 11 has an inlet 30 proximal to the first end 12 through which a stream of fluid flows in the direction of arrow 32 into an interior cavity 16 of the vessel 11. The vessel 11 further includes an interior wall 18 surrounding the interior cavity 16. A plurality of peeling members 25 are supported within the interior cavity 16 and proximal to the interior wall 18. In the embodiment of the floodable peeling apparatus 10 shown in FIG. 1, the first end 12 of the vessel 11 is at a lowermost point on the vessel 11 and the second end is at an uppermost point on the vessel 11. In the embodiment of the floodable peeling apparatus 10 shown in FIG. 1, the vessel 11 has a vertical height 24 and a horizontal diameter 22. The embodiment of the floodable peeling apparatus 10 of FIG. 1 further includes a body chute 38 through which a plurality of bodies 50 may be introduced into the interior cavity 16 of the vessel 11 to be peeled. In the embodiment of the floodable peeling apparatus 11 shown in FIG. 1, the body chute 38 feeds bodies 50A into the interior cavity 16 of the floodable peeling apparatus 10 through an intake port 51 in a floor 17 (not shown in FIG. 1). The embodiment of the floodable peeling apparatus 10 of FIG. 1 further includes a spill basin 40 having a trough 42 disposed about and below the second end 13 of the vessel 11 and in a position to receive the stream of fluid (not shown) as it is discharged from the outlet 19 at the second end 13 of the vessel 11. In the embodiment of the floodable peeling apparatus 10 shown in FIG. 1, the spill basin 40 is sloped downwardly so that a stream of fluid and/or bodies 50A (not shown in trough 42) received into the spill basin 40 will move in the direction of arrow 44 to carry the stream of discharged fluid and/or bodies 50A and/or peelings (not shown) from the bodies 50A to a basin discharge (not shown) that is in the direction of arrow 45. In some embodiments of the floodable peeling apparatus 10 of the present invention, bodies 50A may be discharged from the interior cavity 16 of the vessel 11 through an opening other than the opening through which the stream of fluid is discharged. Similarly, in some embodiments of the floodable peeling apparatus 10

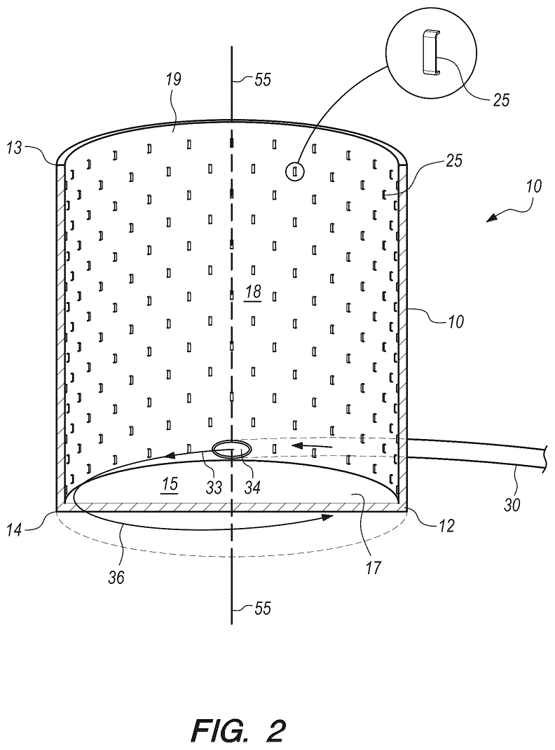

FIG. 2 is a sectional elevation view of the floodable peeling vessel 11 of the apparatus 10 of FIG. 1. The sectional view of FIG. 2 reveals an inlet port 34 through which the stream of fluid (not shown) that flows through the inlet 30 enters the interior cavity 16 of the vessel 11 at a location that is proximal to the first end 12 of the vessel 11. FIG. 2 shows the inlet 30 and the inlet port 34 are positioned so that a stream of fluid (not shown) that enters the interior cavity 16 through the inlet 30 and the inlet port 34 will be directed in an inlet direction indicated by arrow 33, which is off-center relative to a central axis 55. This configuration causes the stream of fluid to create a spinning vortex within the interior cavity 16 as indicated by arrow 36. At the same time, the stream of fluid entering the vessel 11 at the inlet port 34 causes the interior cavity 16 of the vessel 11 to fill until the level of the fluid reaches the outlet 19 at the second end 13 of the vessel 11, and the direction of movement of the fluid within the interior cavity 16 at any location within the vessel 11 is a combination of the spinning vortex about the center axis 55 and the movement of the fluid from the first end 12 to the second end 13. This combination of spinning vortex with movement of fluid from the first end 12 towards the second end 13 causes any bodies that are introduced into the interior cavity 16 of the vessel 11 through, for example, the body chute 38 (shown in FIG. 1 but omitted from FIG. 2) to be propelled by the movement of the fluid along a pathway in which the body will engage, contact and/or hit with a large number of the plurality of peeling members 25 that are supported within the interior cavity 16 and proximal to the interior wall 18 of the vessel 11 that surrounds the interior cavity 16. Each of the peeling members 25, as shown in the enlarged view of one of the plurality of peeling members 25 in FIG. 2, is adapted to remove a small piece of a peel (not shown) from a body 50A (see FIG. 1) having a peel. A body that engages, contacts and/or hits a large number of the plurality of peeling members 25 will emerge from the outlet 19 of the vessel 11 with the peel removed. The small pieces of removed peel (not shown) will be entrained within and carried by the stream of fluid discharged from the interior cavity 16 through the outlet 19 and into, for example, the spill basin 40, if there is one, or they may become stuck within or on some of the plurality of peeling members 25 of the apparatus 10. The pieces of peel that are received into the spill basis 40 can be filtered from the stream of fluid at a downstream process and any pieces of peel that remain in the vessel 11 can be removed upon cleaning.

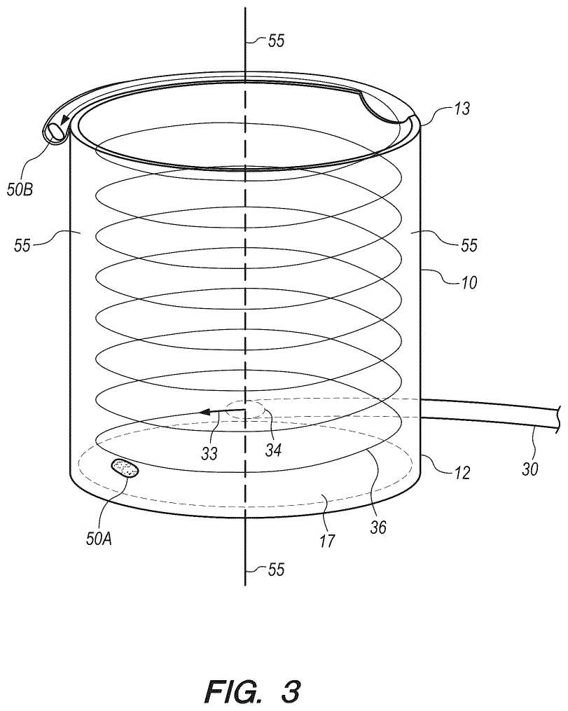

FIG. 3 is a sectional plan view of the apparatus of FIGS. 1 and 2 showing an inlet 30 terminating at an inlet port 34 disposed to direct a stream of fluid to emerge from the inlet port 34 at an inlet direction 33 that is off-center relative to a center axis 55 of the vessel 11. The intake port 34 in FIG. 3 is proximal to a floor 17 of the vessel 11. The spiraling pathway 36 shows the path through which a body 50A might follow after it is introduced into the vessel 11 proximal to the first end 12. The peeling members 25 are not shown in FIG. 3 for simplicity of illustration of the pathway 36.

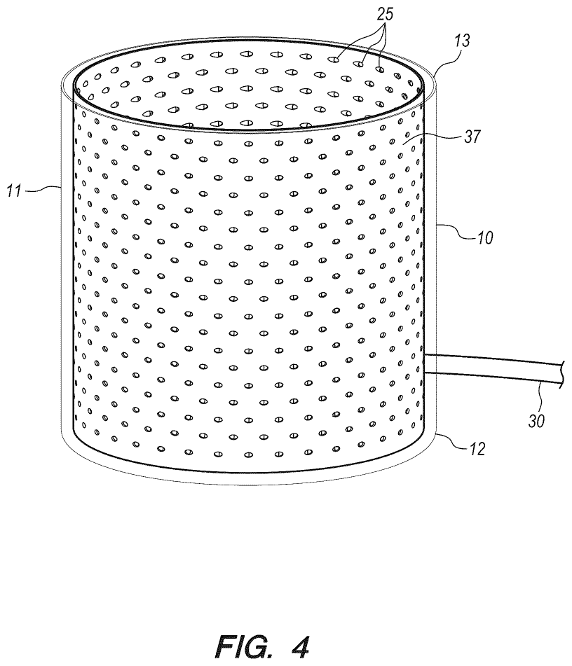

FIG. 4 is an elevation view of a removably insertable liner 37 that can be used to support the plurality of peeling members 25 within the interior cavity 16 of a vessel 11 of an embodiment of an apparatus 10 of the present invention. The vessel 11 of the apparatus 10 of FIG. 4 is transparent to reveal the removably insertable liner 37. In the embodiment of the apparatus 10 of FIG. 4, the insertable liner 37 includes a large plurality of apertures 25 uniformly distributed throughout the liner 37 and the edges of the apertures 25 will, upon being impacted by a body being moved in the spiraling pathway 36 illustrated in FIG. 3, engage and remove a small piece of the peel of the body. FIG. 4 also includes the inlet 30 through which a stream of fluid is introduced into the interior cavity 16 of the vessel 11 of the apparatus 10. The spill basin 40 is now shown in FIG. 4.

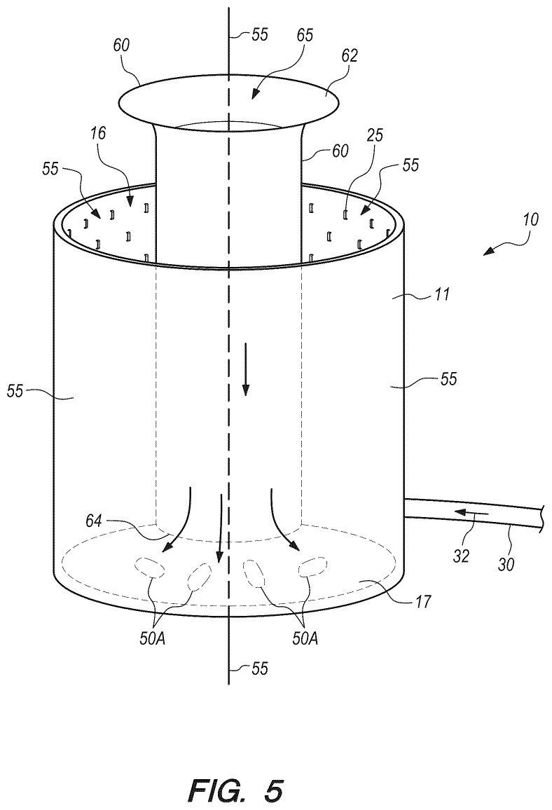

FIG. 5 is an elevation view of an embodiment of an apparatus 10 of the present invention having a centralized body chute 60 for introducing a plurality of bodies into the interior cavity 16 of the vessel 11 of the apparatus 10 for peeling, the body chute terminating prior to engaging the floor 17 of the vessel 11 of the apparatus 10 and being centered about the central axis 55. The centralized body chute 60 includes a top end 62, a bottom end 64 and a bore 65 therebetween. Bodies 50A introduced into the bore 65 at the top end 62 of the body chute 60 descend downwardly along the central axis 55 until they exit the body chute 60 proximal to the floor 17 of the interior cavity 16 of the vessel 11 of the apparatus 10. Once the bodies 50A are discharged from the body chute 60 at the bottom end 64, they become entrained in the flow of the stream of fluid (not shown in FIG. 5) and begin moving along the spiraling pathway 36 illustrated in FIG. 3 which causes the bodies 50A to engage the peeling members 25.

FIG. 6 is a plan view of a vessel 11 of an embodiment of an apparatus 10 of the present invention showing a plurality of inlets 30A, 30B and 30C, each supplying a stream of fluid flowing in the direction of arrows 32A, 32B and 32C, respectively, into the vessel 11 through the inlet ports 34A, 34B and 34C, respectively. The inlet ports 34A, 34B and 34C illustrated in FIG. 6 are angularly separated one from the others by 120 degrees (2.094 radians). In one method of use of the apparatus 10 of the present invention having a plurality of inlet ports 34A, 34B and 34C, the inlet flow to the vessel 11 is equally divided among the three inlet ports 34A, 34B and 34C. This equally distributed inlet flow promotes uniform spinning of the fluid in the interior cavity 16 of the vessel 11 and promotes uniform spinning movement of the bodies (not shown in FIG. 6) as they spin within the vessel 11 and engage the peeling members (not shown in FIG. 6). The bodies 50A, peeling members 25 and the body chute(s) 38 are not shown in FIG. 6 for simplicity and to better demonstrate the distributed inlet ports 34A, 34B and 34C.

FIG. 7 is a sectioned perspective view of an alternate embodiment of the vessel 11 of the apparatus 10 of the present invention having an interior wall 18 that surrounds the interior cavity 16 of the vessel 11. The interior wall 18 includes an abrasive material comprised of a large plurality of small protruding peeling members 25 thereon. This type of abrasive material may be, in one embodiment, applied as a sheet having the peeling members 25 disposed thereon or, alternately, as a fluid material having grit or small hard pieces therein that can be sprayed onto the interior wall 18 and allowed to dry to immobilize the peeling members 25. An advantage of the embodiment of the vessel 11 of the apparatus 10 shown in FIG. 7 is that a vessel 11 can be taken out of service and the abrasive material and peeling members 25 therein can be stripped from the interior wall 18 and a replacement sheet or coating can be applied or sprayed onto the interior wall 18.

FIG. 8 is a perspective view of an alternate embodiment of a vessel 11 of the apparatus 10 of the present invention comprising an upper vessel segment 11A and a lower vessel segment 11B. The upper vessel segment 11A includes an upper flange 21 that is sized and positioned on the upper vessel segment 11A to engage with a mating lower flange 11B disposed on the lower vessel segment 11B. The upper flange 21 of the upper vessel segment 11A and the lower flange 11B of the lower vessel segment 11B may be joined one to the other in an abutting relationship as shown in FIG. 8 using a plurality of threaded posts 26 fitted with threaded nuts 27. An upper vessel segment 11A and a lower vessel segment 11B may, in other embodiments, be secured one to the other using clamps, latches, etc. Some embodiments of the alternate embodiment of the vessel 11 may comprise two, three or more segments.

“Fluid,” as that term is used herein, includes either liquid or gas. In preferred embodiments of the present invention, the specific density of the bodies is higher than the density of the fluid. In most applications where pieces removed from the bodies comprise a solid material, the fluid will be a liquid.

“Peeling” and “skinning,” as those terms are used herein, include peeling, skinning, abrading, rubbing and buffing, and all other terms that indicate that a small bit or piece of material is removed as a result of the peeling or skinning. An abrasive surface, for example, may be one that includes a large number of very small peeling members thereon, whereas the peeling members may also be larger and separated one from the others as depicted in some drawings appended hereto. Although the drawings appended hereto show larger, separated peeling members for visual representation, this should not be taken as limiting of the size or shape of the peeling members.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus to remove a peel from a plurality of bodies, comprising:
a vessel having a first end, a second end with an outlet, an interior cavity intermediate the first end and the second end, and an interior wall surrounding the interior cavity with at least a portion of the interior cavity having a circular cross-section and a center axis therethrough;
a plurality of peeling members supported within the interior cavity and proximal to the interior wall; and
an inlet coupled to the vessel to introduce an inlet stream of fluid into the interior cavity of the vessel at an inlet direction that is off-center relative to the center axis of the at least a portion of the vessel, the inlet being proximal to the first end of the vessel;
wherein introducing a stream of a fluid through the inlet and into the interior cavity of the vessel in the inlet direction fills the interior cavity from the inlet to the outlet and produces a spinning vortex of the fluid about the center axis and within the at least a portion of the interior cavity; and
wherein introducing the plurality of bodies with peels into the interior cavity while continuing to introduce the stream of the fluid causes the plurality of bodies to be accelerated in a spiraling pathway about the center axis by the spinning vortex and causes the plurality of bodies to engage the interior wall and at least some of the plurality of peeling members.

2. The apparatus of claim 1 wherein the center axis is vertical.

3. The apparatus of claim 1, further comprising:
a body chute fluidically coupled to the vessel and through which the plurality of bodies can be introduced into the interior cavity.

4. The apparatus of claim 3 wherein the body chute is coupled to the vessel proximal to introduce the plurality of bodies into the interior cavity of the vessel proximal to the first end.

5. The apparatus of claim 1 wherein the plurality of peeling members are supported on an insert that is sized for being removably received within the interior cavity.

6. The apparatus of claim 5 wherein each of the plurality of peeling members comprises an edge of an apertures in the liner.

7. The apparatus of claim 1 wherein the plurality of peeling members are connected to the interior wall of the interior cavity.

8. The apparatus of claim 1, further comprising:
a spill basin disposed proximal to the outlet proximal to the second end of the vessel to receive the plurality of bodies, the fluid and a plurality of peelings from the vessel.

9. The apparatus of claim 6, further comprising:
a trough of the spill basin having a first end to receive the plurality of bodies from the spill basin and a second end to discharge the plurality of bodies.

10. The apparatus of claim 1, wherein the inlet is coupled to the vessel to introduce the inlet stream having the direction tangential to the center axis.

11. An apparatus to remove portions of a peel from each of a plurality of bodies, comprising:
a vessel having an interior cavity, an inlet proximal to a first end through which a stream of fluid can be introduced into the vessel, an outlet at a second end through which the stream of fluid is discharged from the vessel, and a plurality of peeling members supported proximal to an interior wall that surrounds the interior cavity of the vessel.

12. The apparatus of claim 11, wherein the plurality of peeling members are connected to the interior wall.

13. The apparatus of claim 11, wherein the plurality of peeling members are supported within the interior cavity proximal to the interior wall by a removable insert.

14. The apparatus of claim 11, further comprising a body chute through which the plurality of bodies can be introduced into the interior cavity proximal to the first end.

15. The apparatus of claim 11, further comprising a spill basin positioned to receive the stream of fluid as it is discharged from the outlet.
